(19) United States
(12) Patent Application Publication
(10) Pub. No.: US 2018/0285581 A1
(43) Pub. Date: Oct. 4, 2018

(54) System and Method for Protecting Information from Unauthorized Access

(71) Applicant: GEOFFREY BERNARD GRINDROD, (US)

(72) Inventor: GEOFFREY BERNARD GRINDROD, (US)

(21) Appl. No.: 15/476,198

(22) Filed: Mar. 31, 2017

(51) Int. Cl. G06F 21/62; G06F 21/57; G06F 21/56

(52) U.S. Cl. CPC G06F 21/6218; G06F 2221/034; G06F 21/566; G06F 21/57

(57) ABSTRACT

In a digital computing environment, a method of protecting stored and transmitted computer files from unauthorized access, by rearranging the internal structure of the file's byte data into a specified non-linear sequence, and storing them into a series of site-specific data files, which can then be individually stored across two or more physical and/or online locations to implement an effective form of file security. A user selects the files they want to protect, along with the number of physical sites they wish to use to protect their files. Each file is processed at the bitwise level, with each successive bit from each successive byte being appended to the next successive site data file. When the last site data file is reached, the process continues back at the first site data file. The resulting output is a series of site data files which, when physically separated, cannot be accessed by an attacker, without having all other site data files available.

### FIELD OF THE INVENTION

The present invention relates generally to methods, systems and software for protecting stored information from unauthorized access, including interception by people, such as as cyber-criminals, nation-state actors; software, such as malware, APTs, trojans, ransomware, remote access trojans that may infiltrate a computer or other digital processor.

In particular, the present invention relates to methods, systems and software that rearranges and separates the bitwise structure of sensitive data files into separate, nonlinear site data files, which can then be individually stored in separate physical and/or online locations to accomplish effective data protection. Sensitive data files could include documents, customer databases, sensitive company information, client information, contacts lists, spreadsheets, custom/proprietary data files, and media such as photographs and movies.

### BACKGROUND OF THE INVENTION

As use of the Internet increases, the resulting problems and harmful effects of cyber-attacks, including targeted attacks, advanced persistent threats (APTs), and ransomware, results in an ever-increasing incidence of systems compromise, and theft and loss of stored information (data breaches).

In the systems realm, cyber-attacks present a substantial security risk to files and information that are holistically stored and accumulate on, or are transmitted to/from computer systems that exist as servers, virtualized systems, mobile devices, dedicated-purpose (IoT) devices, or desktop systems.

Additionally, physical security risks, such as theft and corporate espionage also present a security risk to stored files and information that is holistically stored in one physical location on, for instance a server, storage media such as CD/DVD/Blu-ray, flash storage, network attached storage, or removable drives.

To protect files and information from reverse engineering/decryption, new methods of encryption, such as RSA, AES, DES, and recently Quantum Encryption are developed to supersede older methods. These methods are constantly being subject to reverse engineering investigation processes, with some having historically been subverted by ongoing intense investigation by the scientific community, and hackers.

These people have the advantage of a steady increase in available, low cost, hardware systems processing power, along with previously unconsidered approaches to reverse engineering, such as exploiting buggy or neglected implementations and side channel attacks. When combined with time, effort and processing power, the chances of successfully reverse engineering these current methods of encryption increases.

Most forms of encryption produce transformed representations of files and information that exist holistically in one physical or online location, and are stored and commonly even neglected there, over a significant period of time. As a result, when the encryption is ultimately reverse-engineered, the original information is fully available to the attacker.

It would be desirable to provide methods, systems and software products that could enable the user to conveniently prepare their files and information for a more definitive type of file protection which uses physical separation, online separation, or a mix of both, as a key factor in securing the data.

This approach would result in a more reliable form of file protection that is more resilient against data breaches and physical security breaches over time. It would give the owner more peace of mind, and reduce the necessity for them to continually monitor access to, and regularly re-encrypt their files and information over time, as existing methods of encryption become obsolete or outdated.

Examples of Cyber-Attacks
Targeted Attacks: (an example of which is StuxNet) is a class of malware destined for specific organizations or industries. A type of crime-ware, these threats are of particular concern because they are designed to capture sensitive information and even control automated systems in the physical realm. Targeted attacks may include threats delivered either via social engineering tactics, or directly via e-mail, port attacks, zero day attack vulnerability exploits or phishing messages. Government organizations and Financial industries are examples of the most targeted industries.
Advanced Persistent Threat (APT): (an example of which are Xagent, or Grizzly Steppe) is a set of stealthy and continuous computer hacking processes, often orchestrated by a person or persons targeting a specific entity. An APT usually targets either private organizations, states or both for business or political motives. APT processes require a high degree of covertness over a long period of time. The “advanced” process signifies sophisticated techniques using malware to exploit vulnerabilities in systems. The “persistent” process suggests that an external command and control system is continuously monitoring and extracting data from a specific target. The “threat” process indicates human involvement in orchestrating the attack.
Malware: (an example of which is Dridex) short for malicious software, includes viruses, bots, bugs, ransomware, spyware, root-kits, trojan horses, backdoors, key-loggers, rogue security software, and hijackers. It is any software used to disrupt computer or mobile operations, gather sensitive information, gain access to private computer systems, or display unwanted advertising. These days malware is also used as a core component of Targeted Attacks and APTs.
Ransomware: Such software: (an example of which is Crypt® Locker, or Dharma) is computer malware that installs covertly on a victim's computer, executes a crypto-virology attack that adversely affects files on the computer, and demands a ransom payment to decrypt or not publish them. Simple ransomware may lock files in a way that is not difficult for a knowledgeable person to reverse, and display a message requesting payment to unlock it. More advanced ransomware encrypts the victim's files, making them inaccessible, and demands a ransom payment to decrypt them.
Remote Access Trojan (RAT): (an example of which is Sakula) is a piece of software that allows a remote “operator” to control a system as if they have physical access to that system. While desktop sharing and remote administration have many legal uses, “RAT” software is usually associated with criminal or malicious activity. Malicious RAT software is typically installed without the victim's knowledge, often as payload of a Trojan horse, and will try to hide its operation from the victim and from security software.
Computer and Network Surveillance Software: (an example of which is Teramind) allows the monitoring of computer activity and data stored on a hard drive, or data being transferred over computer networks such as the Internet. The monitoring is often carried out covertly and may be completed by governments, corporations, criminal organizations, or individuals. It may or may not be legal and may or may not require authorization from a court or other independent government agency.
Trojanized Software: (an example of which is the fake version of PuTTY—an open source terminal emulator) is legitimate software that has been modified or compromised in some way that changes it's behavior for malicious purposes. Software can also start out as being legitimate, then later have it's behavior changed via a software update.
Operating System and Software Vulnerabilities: (an example of which is CVE-2016-3321) is a weakness which allows an attacker to reduce a system's information assurance. Vulnerability is the intersection of three elements: a system susceptibility or flaw, attacker access to the flaw, and attacker capability to exploit the flaw. To exploit a vulnerability, an attacker must have at least one applicable tool or technique that can connect to a system weakness. In this frame, vulnerability is also known as the attack surface.
Social Engineering Attacks: (an example of which are falsified e-mails from the IRS, FedEx, and Financial Institutions) trick the user into installing malware components, such as the Zeus banking trojan. From there, account passwords can be captured and used to gain access to online services, including file storage and online banking services.
Man-in-the-middle Attacks: occur when someone between you and the system or entity with whom you are communicating is actively monitoring, capturing, and controlling your communication transparently. For example, the attacker can re-route a data exchange. When computers are communicating at low levels of the network layer, the computers might not be able to determine with whom they are exchanging data.
Sniffer Attacks: occur when an application or device is employed on a computer network that can read, monitor, and capture network data exchanges and read network packets. If the packets are not encrypted, a sniffer provides a full view of the data inside the packet. Even encapsulated (tunneled) packets can be broken open and read unless they are encrypted and the attacker does not have access to the key.
Application-Layer Attacks: occurs when an attacker creates a fault in a server's operating system or applications. This results in the attacker gaining the ability to bypass normal access controls. The attacker takes advantage of this situation, gaining control of your application, system, or network.
Compromised-Key Attack: occurs when an attacker illegally obtains a key through nefarious monitoring and infiltration of a network. After an attacker obtains a key, that key is referred to as a compromised key.
Brute Force Password Attacks: (an example of which is LOphtcrack) are a trial and error method used by application programs to decode encrypted data such as passwords or Data Encryption Standard (DES) keys, through exhaustive effort (using brute force) rather than employing intellectual strategies.

Examples of Physical Attacks
Accidental Physical Data Loss—storage media with sensitive data is lost by the user. Example: A USB stick with sensitive patient information is left accidentally in a rental car by a hospital employee.
Physical Neglect—sensitive information made available to an attacker as a result of physical neglect of the sensitive data. Example: Sensitive backup data is left on DVD's in an unlocked storage room that is accessible by anyone.
Physical Theft—sensitive data files are targeted and stolen by an employee via physical means. Example: A disgruntled employee targets and steals a series of backup tapes from a co-workers office.

### SUMMARY OF THE INVENTION

The present invention provides the methods, systems and tools to protect files by processing their content in the manner described, and outputting a series of protected site data files that can be individually stored across a series of physical and/or online locations. It also provides the ability to collect back the protected volumes, and restore the original files to their original form.

Additional detail of embodiments and practices in accordance with the present invention will next be set forth in connection with the attached drawings.

### BRIEF DESCRIPTION OF DRAWINGS

FIG. 1 is a flowchart describing the process of protecting original files using bit separation, and outputting them to a series of site data files, in accordance with the protective aspect of the present invention

FIG. 2 is a flowchart describing the process of collecting or re-grouping the site data files that were originally created during the protect process, in preparation for a restore.

FIG. 3 is a flowchart describing the process of restoring a series of site data files to the original unprotected file, in accordance with the restorative aspect of the present invention.

FIG. 5 is a screenshot depicting a file protection application allowing the user to select how many storage sites to use for file protection, in accordance with the present invention.

FIG. 6 is a screenshot depicting a file protection application allowing the user to select files that they wish to protect, in accordance with the present invention.

FIG. 7 is a screenshot depicting a file protection application allowing the user to collect/regroup the site data files back together, in preparation for a restore of the files, in accordance with the present invention.

FIG. 8 is a screenshot depicting a file protection application allowing the user to restore a selected set of site data files—the session, in accordance with the present invention.

FIG. 10 is a diagram of a possible deployment scenario with 2 site data files deployed to 2 different cloud storage providers.

FIG. 11 is a diagram of a possible deployment scenario with 2 site data files deployed to a cloud storage provider, and a users home.

FIG. 12 is a diagram of a possible deployment scenario with 3 site data files deployed to a cloud storage provider, a users home, and a safe deposit box at the users financial institution.

FIG. 13 is a diagram of a possible deployment scenario with 2 site data files deployed to 2 different e-mail hosting providers.

### DETAILED DESCRIPTION OF THE INVENTION

### Overview

The present invention provides methods, systems and software products that may in turn be part of a larger software system or product, for protecting files by converting them into a series of protected site data files, and collecting and restoring these site data files on a users computer system.

This approach to file protection empowers the user to choose their own physical and online storage locations for each of the individual site data files. The knowledge of the location of the sites chosen to store the site data files becomes a significant factor of protection as it is challenging for an attacker to glean or reverse engineer this information if it is properly protected by the owner. This challenge is magnified because, depending on the deployment approach, the attacker may also have to physically travel to one or more locations in order to recover the site data files necessary to restore the original information. This approach to file protection is broad, and can be applied to many different data protection scenarios. An example of an especially useful application is for protecting files and information that needs to be stored, and might possibly be neglected over a long period of time.

Those skilled in the art will understand that the methods, data structures and software techniques that will next be described, can be implemented, using known computer software and hardware principles, on a conventional personal computer (PC/Mac) or other computing device or system, whether networked or standalone, desktop, server, handheld, wireless, Internet of Things (IoT) devices, or other digital processing platforms.

Method 1: File Protection Process

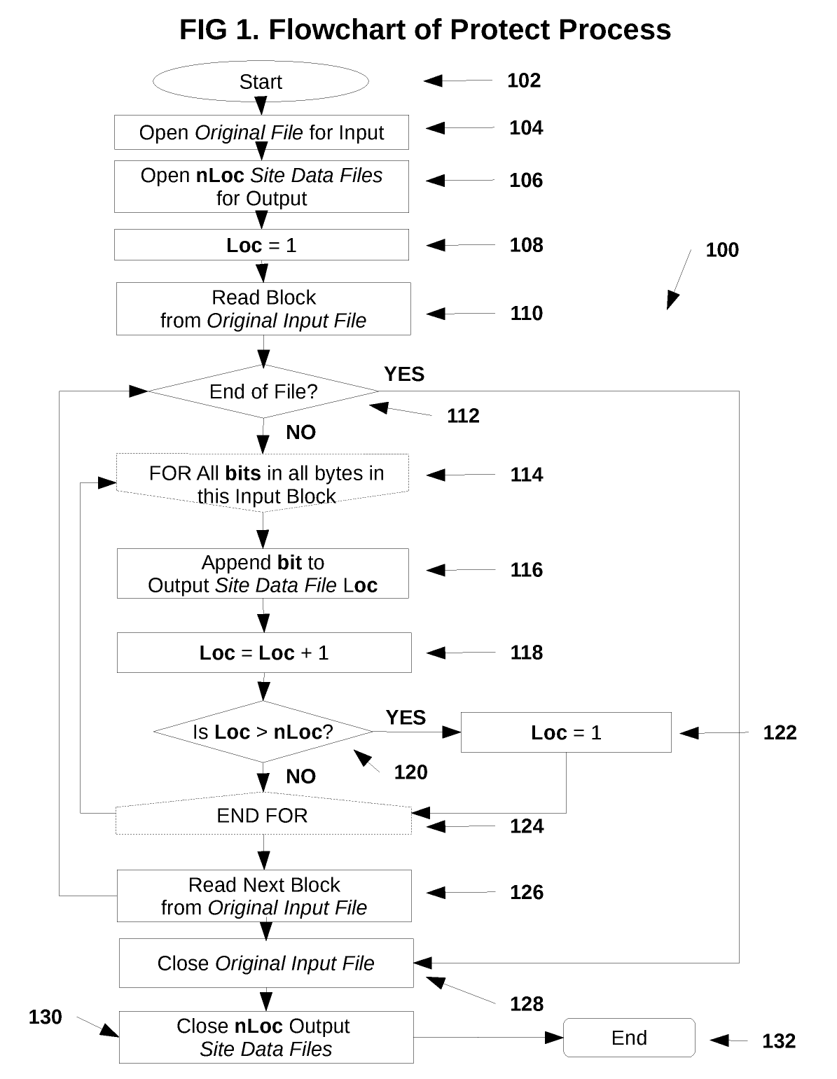

In accordance with an embodiment of the invention, and referring now to FIG. 1, a file protection method 100 employs an algorithm that sequentially iterates through each bit in a given original input file, appending each successive bit to each in a series of output site specific data files.

The original file to be protected is opened for input at 104. Following this, a series of “nLoc” site data files is created for output at 106. A counter, “Loc” is used to identify the first/next site-specific data file to write the next bit to, and is initialized to 1 at 108. The first block of the original input file is read at 110. If the read is successful, a FOR loop commences at 114, which is used to iterate through all of the bits in the block that was read at 110/126. At 116, each successive bit from the input stream is appended to the next successive site data file specified by “Loc”, which is incremented by 1 at 118 and reset to 1 at 122 if it goes beyond the number of desired sites. Following this, the next block is read from the original input file at 126, and the process continues until the end-of-file, or an error occurs.

Following the closure of the read loop the original input file is closed at 128, along with the output site data files at 130. The process then ends, resulting in nLoc output site data files, which can then be stored by the user at separate logical and/or physical locations.

This method is effective for protecting the original file from unauthorized access and reverse engineering, because it creates a group of site data files—each of which is a partially depleted, nonlinear representation of the original file. Due to this form of representation, none of the site data files can be used individually or in multitude to reveal any usable part of the original file information without having all site data files available. When this storage approach is coupled with the practice of storing each site data block in a separate physical or online location, or a mix of both, the result is an exceptionally secure method of file and information protection.

Method 2: Site Data File Collection/Regrouping Process

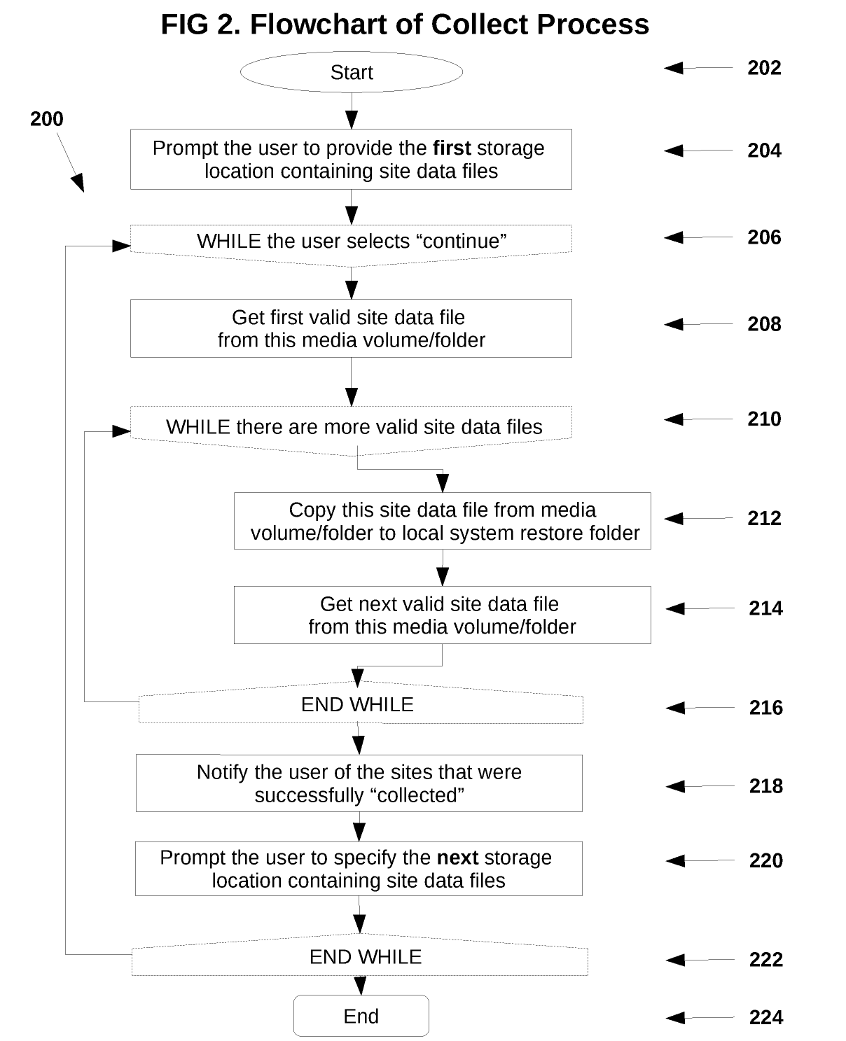

In accordance with another embodiment of the invention, and referring now to FIG. 2, a site data file collection method 200 employs an algorithm that automates the collection and regrouping of site data files that the user has previously deployed across separate physical and online storage locations.

The user is prompted to mount/provide the first media volume/folder/remote folder that contains site data files at 204. If they choose to continue, a WHILE loop is entered at 206 which will be responsible for repeatedly prompting the user for the first/next media volume/folder/remote folder to collect from. At 208 a check is performed for any site data files that exist in the media volume/folder/remote folder specified by the user. If any site data files exist, a WHILE loop is entered at 210-216 which copies all of the site data files from each user-specified media volume/folder/remote folder to a local system restore folder, from where the user can restore their original files. Following the successful collection of all site data files from each selected volume/folder, the user is notified of success at 218, and prompted for the next media volume/folder containing site data files at 220.

Following the closure of the outer WHILE loop at 222, the process ends at 224, resulting in the set of original site data files, stored in one local system folder location, in preparation for the restore process.

This method eases the process of collecting, identifying and regrouping the original site data blocks that the user has made available from folders on various storage media, in preparation for a restore.

Method 3: File Restoration Process

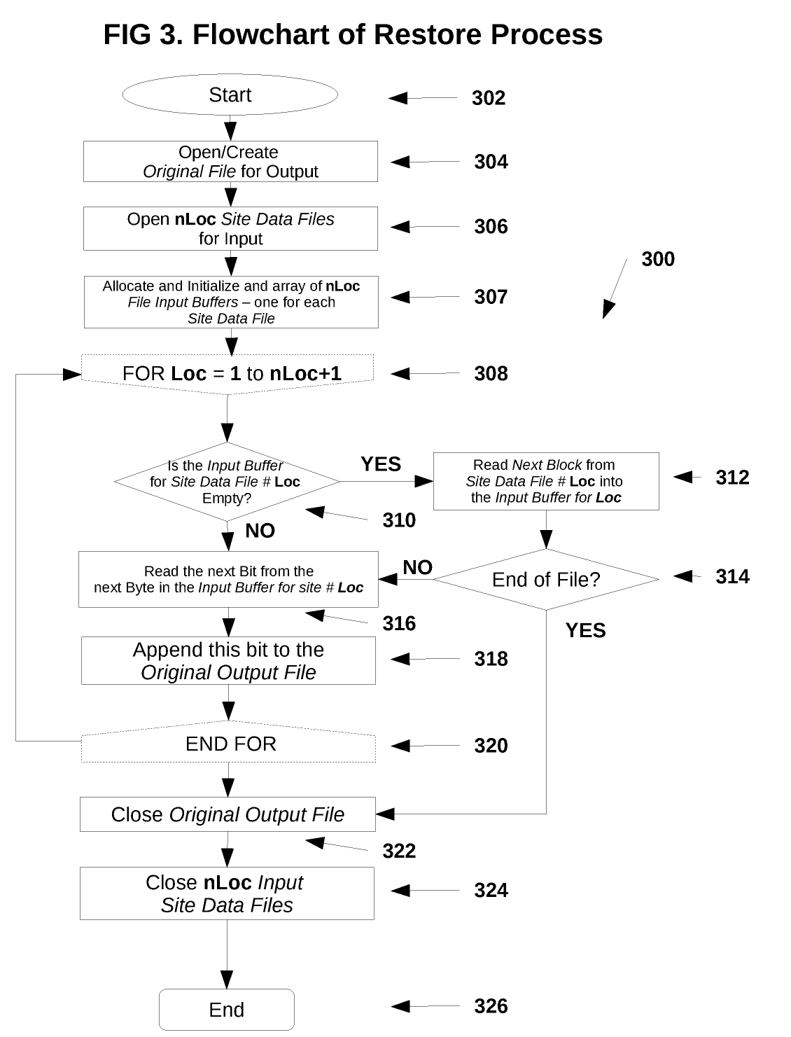

In accordance with another embodiment of the invention, and referring now to FIG. 3, a file restoration method 300 employs an algorithm that sequentially iterates through each successive bit in each successive byte, in each of a series of successive input site data files, appending each bit read, to the original output file that is being restored.

The original file to be restored is created for output at 304. Following this, the set of site data files is opened for input at 306. At 307, a series of nLoc site data file input buffers is allocated and initialized. A FOR loop at 308 is then used to cycle through each site data file, checking and re-filling the input buffer for site data file Loc at 310/312. At 316, each successive bit from each successive byte of the input buffer for Loc is read. This bit is then appended back to the original output file at 318. This process repeats until an end-of-file or error occurs on one of the input site data files.

Following the closure of the read loop the original output file is closed at 322, along with the input site data files at 324. The process then ends, resulting in the original file that was protected being available for use by the user.

This method is effective for recombining the bits of data within the separate site storage blocks, back to into their original files, so that these files may be accessed again.

Examples of Operation/Screenshots:

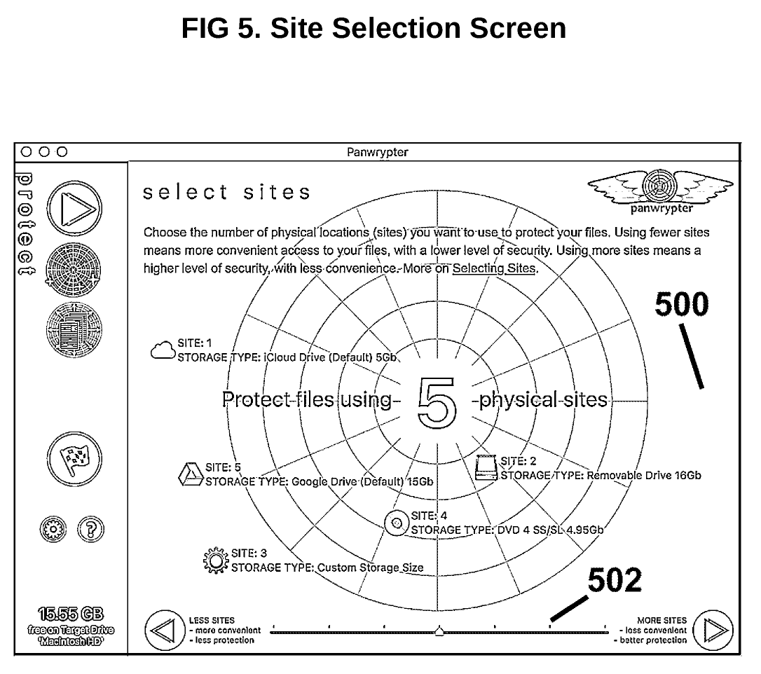

In accordance with a further practice and embodiment of the invention, FIG. 5 is a screenshot depicting the storage site selection area 500 of the invention. The slider bar at 502 allows the user to select the number of storage sites they wish to use to protect their files. The output of this screen is the number of sites selected—nLoc, which is input to Method 1 and determines the total number of site data files that will be created from the original files.

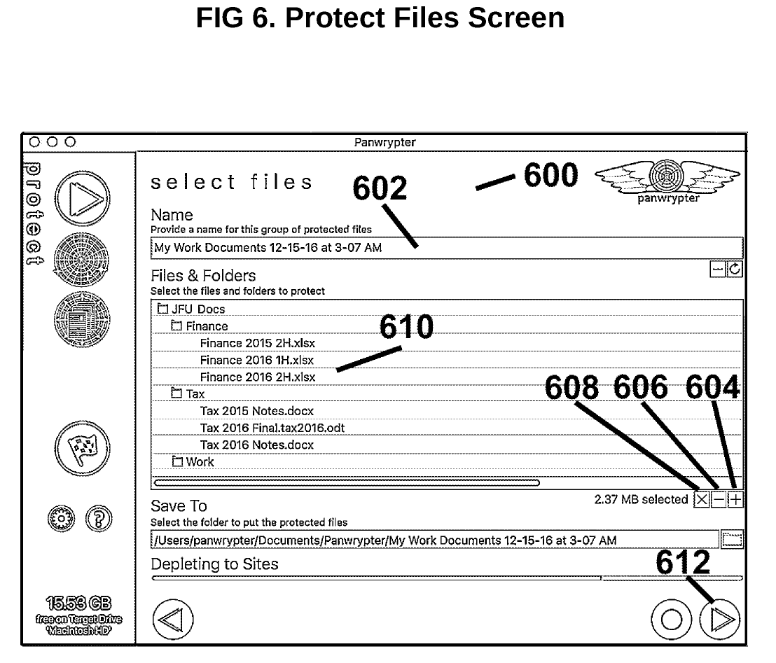

In accordance with a further practice and embodiment of the invention, FIG. 6 is a screenshot depicting the file selection area 600 of the invention. The user provides a name for this group of files at 602—sessionName. The add 604, remove 606 and clear 608 buttons allow the user to specify a list of files that they want to protect at 610—selFiles. Selecting the next button at 612 will initiate Method 1 with the session name—sessionName, the number of sites—nLoc, and the selected files—selFiles, as inputs.

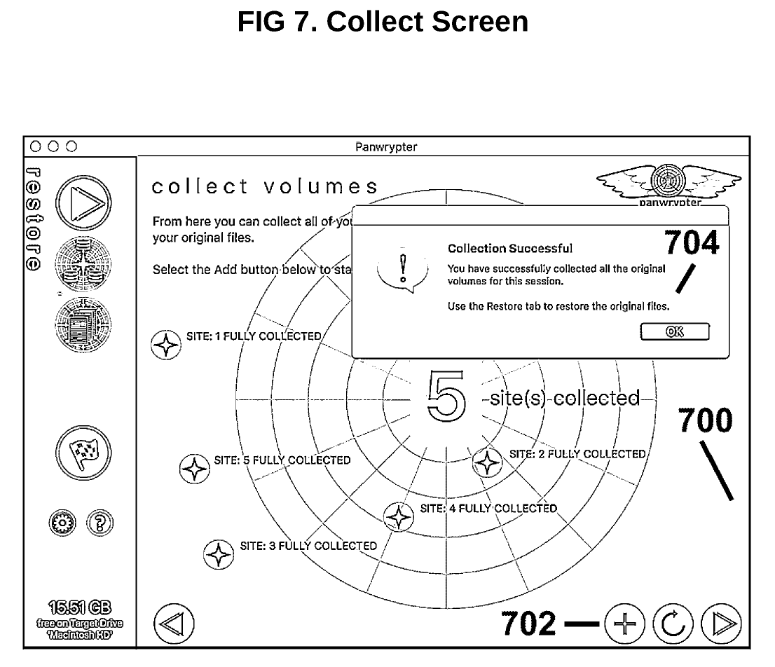

In accordance with a further practice and embodiment of the invention, FIG. 7 is a screenshot depicting the site data file collection area 700 of the invention that is the user interface to Method 2 of the invention. The user repeatedly selects the add button at 702 to provide the location (volume/folder/remote folder) of the first/next site data file(s). Following each location selection, the site data files from said location are collected and stored in a local restore folder—the session folder. In addition, the user interface is updated to show which site data files have been collected, and which are remaining. When they have finished collecting all site data files, a completion notification is displayed at 704, and the collection of site data files—the session—is now ready for restore.

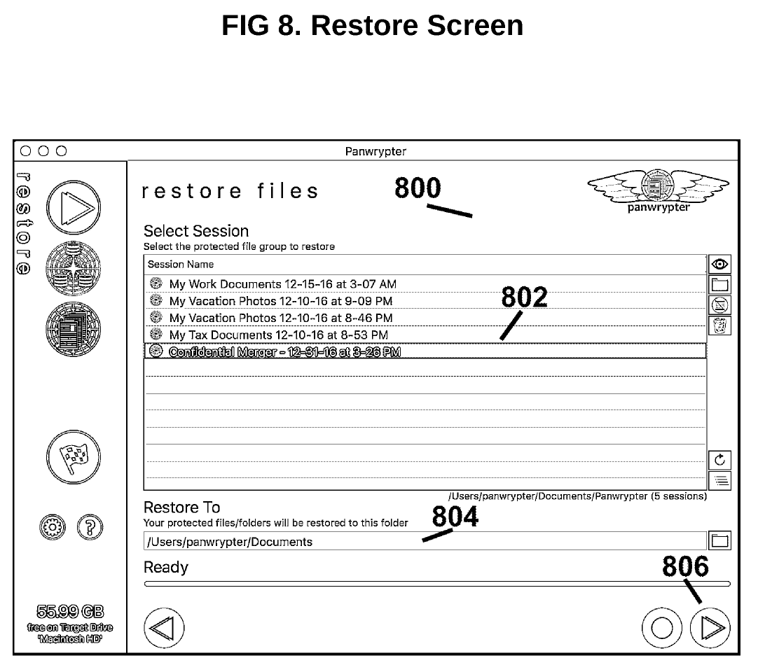

In accordance with a further practice and embodiment of the invention, FIG. 8 is a screenshot depicting the session restore area 800 of the invention. The user selects the group of site data files—the session—from a list of available restore sessions at 802. At 804, the user selects the folder to which the protected files in this session will be restored to. Selecting the next button at 806 will prompt the user to proceed with the restore, which then initiates Method 3 to restore the original files from the collection of site data files—the session.

In accordance with a further practice and embodiment of the invention, FIG. 8 is a screenshot depicting the session restore area 800 of the invention. The user selects the group of site data files—the session—from a list of available restore sessions at 802. At 804, the user selects the folder to which the protected files in this session will be restored to. Selecting the next button at 806 will prompt the user to proceed with the restore, which then initiates Method 3 to restore the original files from the collection of site data files—the session.

In accordance with a further practice and embodiment of the invention, FIG. 8 is a screenshot depicting the session restore area 800 of the invention. The user selects the group of site data files—the session—from a list of available restore sessions at 802. At 804, the user selects the folder to which the protected files in this session will be restored to. Selecting the next button at 806 will prompt the user to proceed with the restore, which then initiates Method 3 to restore the original files from the collection of site data files—the session.

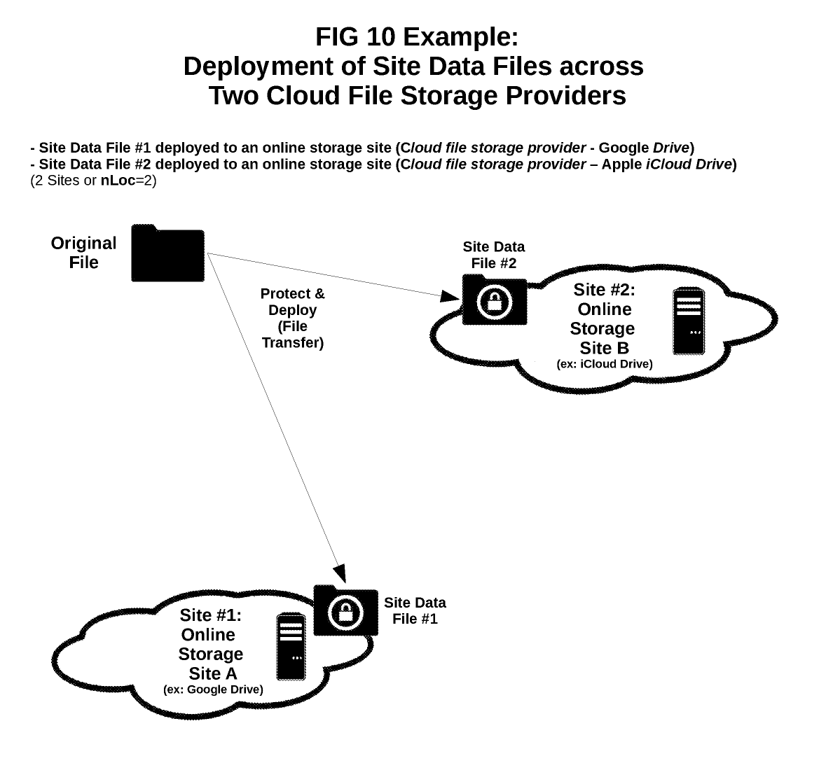

In accordance with a further practice and embodiment of the invention, FIG. 10 is a diagram of a possible deployment scenario with 2 site data files. Each site data file is deployed to a different cloud file storage provider—Google Drive, under the control of Google, Inc. and Apple iCloud Drive, under the control of Apple, Inc. Due to the partial and nonlinear storage nature of the site data files, if one cloud storage provider is breached, the site data file cannot be reverse engineered without the other site data file.

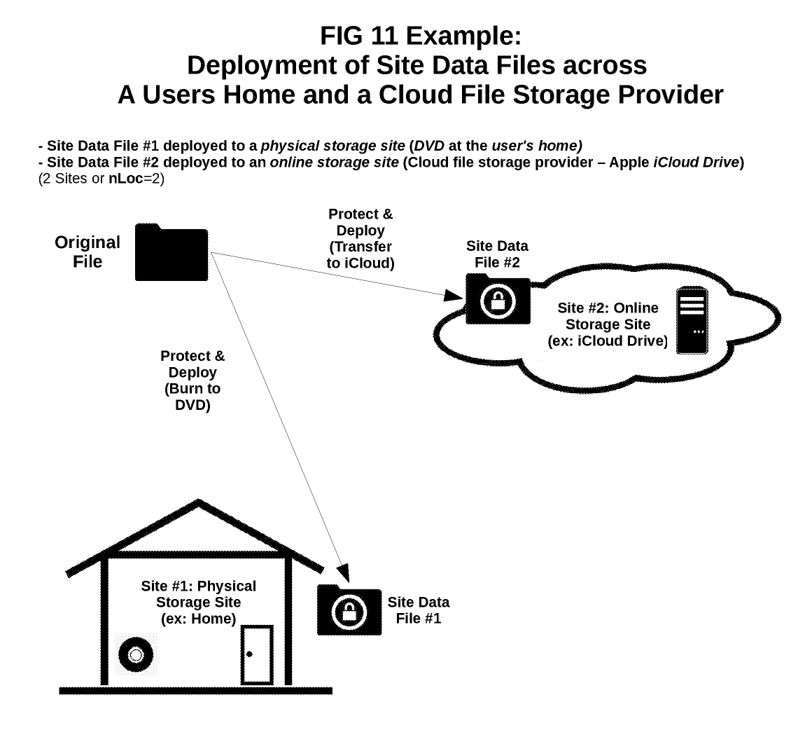

In accordance with a further practice and embodiment of the invention, FIG. 11 is a diagram of a possible deployment scenario with 2 site data files. One site data file is deployed to a cloud file storage provider—Google Drive, under the control of the provider—Google, Inc. The other site data file is deployed to a selected location at the users home, which is under the control of the user. Due to the partial and nonlinear storage nature of the site data files, if one site is breached, the site data file cannot be reverse engineered without the other site data file.

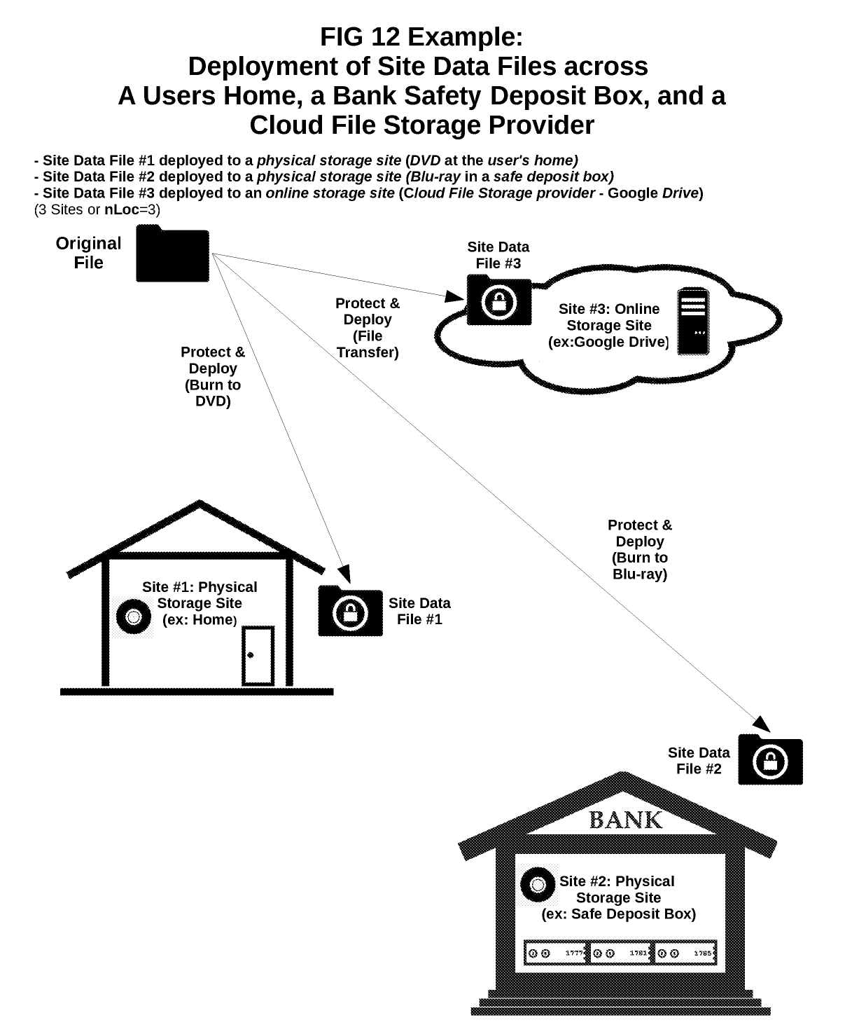

In accordance with a further practice and embodiment of the invention, FIG. 12 is a diagram of a possible deployment scenario with 3 site data files. One site data file is deployed to a selected location at the users home, under the control of the user. The next site data file is deployed to a cloud file storage provider—Google Drive, under the control of Google, Inc. The last site data file is deployed to a safety deposit box at the users finance institution, under the control of the finance institution. Due to the partial and nonlinear storage nature of the site data files, if one or two sites are breached, the site data files cannot be reverse engineered without the remaining site data file.

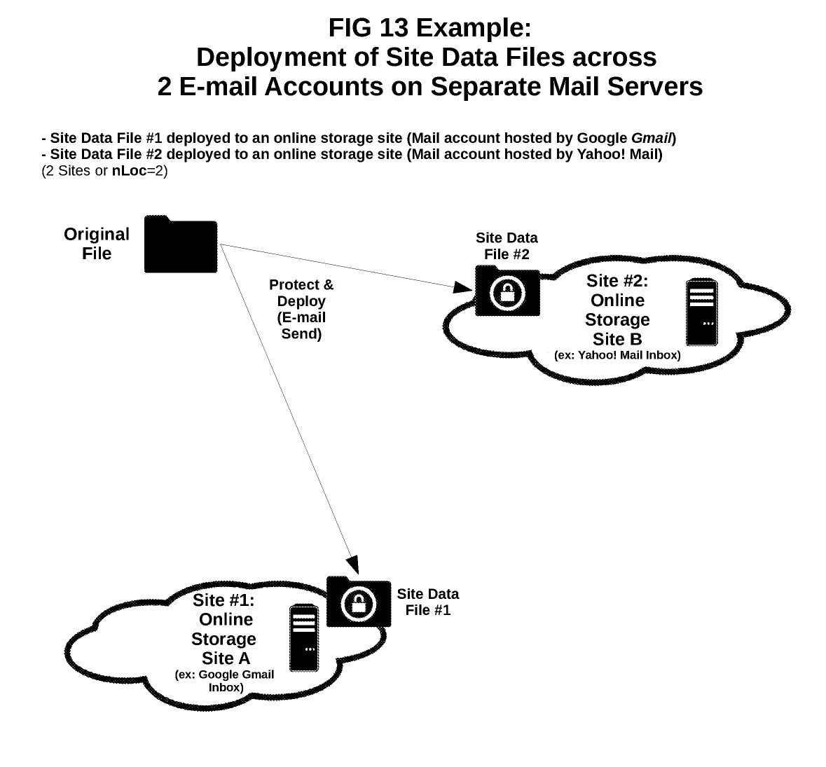

In accordance with a further practice and embodiment of the invention, FIG. 13 is a diagram of a possible deployment scenario with 2 site data files. One site data file is e-mailed as an attachment to one e-mail account owned by the user, and resides in their e-mail inbox, under the control of one e-mail hosting provider. The other site data file is sent to the user's other e-mail account, and resides in their e-mail inbox, under the control of another e-mail hosting provider. Due to the partial and nonlinear storage nature of the site data files, if one e-mail hosting provider is breached, the site data file cannot be reverse engineered without the other site data file.

### CONCLUSIONS

Those skilled in the art will understand that the invention described herein by way of example provides significant protective advantages over the prior art, by enabling a user to protect files by transforming them into a series of protected site data files that they can separate and distribute across several physical and/or online location(s), which are difficult for hackers to discover and physically obtain.

Those skilled in the art will also appreciate that the foregoing examples are provided by way of illustration and detailed description, and that numerous variations, modifications, additions and changes are possible, and are within the spirit and scope of the invention.

Those skilled in the art will also appreciate that the methods, systems and software products of the present invention are applicable to a virtually unlimited range of computing platforms, including personal computers (PCs/Macs), handheld or wireless computing devices, Internet of Things (IoT) devices, or any other networked or standalone computing platforms. The methods, systems and software products described herein can also be used to protect files and file types other than those described by way of example above.

We claim:

1. A method for protecting a series of selected files by breaking them into a series of protected site data files, the method comprising: receiving a selection from the user on a graphical user interface indicating the number of storage sites to be used for protecting the files—nLoc; receiving a selection from the user on a graphical user interface about which files they want to be protected—selFiles; processing the content of each file from selFiles by reading each successive bit from each successive byte of the original input file; processing each newly created output file by appending each previously read bit in turn, to a series of newly created output site data files.

2. The method of claim 1 wherein the processing of each original input file from selFiles is performed from the start of the file to the end of the file by sequentially reading each successive bit from each successive byte of the input file.

3. The method of claim 1 wherein the processing of each newly created output site data file is performed by storing each successive bit read from each file in selFiles input files, to the next successive output site data file.

4. A method for restoring the original files from the protected site data files, the method comprising: receiving information about the location of each site data file from the user on a graphical user interface, and copying each site data file from a selected volume/folder/remote folder to a local restore folder; receiving a selection from the user on a graphical user interface about which set of collected site data files that should be restored (the session); receiving a selection from the user on a graphical user interface about the folder that this session should be restored to; processing each input site data file by reading each successive bit from each successive byte in turn, from each successive site data file; processing each newly created original output file by appending each previously read bit in turn, to said original output file.

5. The method of claim 4 wherein the regrouping and collection of the originally distributed site data files is performed by repeatedly prompting the user for the location of the first/next site data file, and copying said site data file from the selected volume/folder/remote folder to a single restore folder on the users filesystem, in preparation for the restore process.

6. The method of claim 4 wherein the processing of a series of nLoc input site data files (the session) is performed by sequentially reading each successive bit from each successive byte, in turn, from each of the collected site data files in the session.

7. The method of claim 6 wherein the processing of each output original file is performed by appending each successive bit read, back to the original output file.
